(19) United States
(12) Patent Application Publication
(10) Pub. No.: US 2006/0022635 A1
(43) Pub. Date: Feb. 2, 2006

(54) Battery chargers

(75) Inventors: Yiu Cheung Li, Hong Kong SAR (CN); Kai Ming Huang, Shenzhen (CN)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: GPE International Limited, Hong Kong SAR (CN)

(21) Appl. No.: 10/902,375

(22) Filed: Jul. 30, 2004

(51) Int. Cl. H02J 7/00

(52) U.S. Cl. 320/107

(57) ABSTRACT

A battery charger comprising an AC power input, isolation switching means, isolation control means, battery charging circuitry and battery receptacle, said isolation switching means substantially isolates said battery charging circuitry from said AC power input unless and until actuated by said isolation control means, said isolation switching means connects said battery charging circuitry to said AC power input for battery charging when actuated, wherein the operation of said isolation switching means being linked to the state of electrical insulation of said battery charging circuitry, said isolation control means and said isolation switching means being cooperatively configured so that said isolation switching means is actuated when said battery charging circuitry is electrically insulated from a user and said isolation switching means is caused to isolate said battery charging circuitry and said AC power input when said battery charging circuitry is not electrically insulated from a user.

### FIELD OF THE INVENTION

The present invention relates to battery chargers and, more particularly, to battery chargers with AC power input. More specifically, although of course not solely limited thereto, this invention relates to battery chargers for charging dry rechargeable batteries such as NiMH, NiCd and Lithium batteries. Yet more specifically, this invention relates to fast battery chargers for consumer applications.

### BACKGROUND OF THE INVENTION

Rechargeable batteries are widely used in portable or mobile applications, devices and/or appliances. Cellular and cordless telephones, remote repeaters, remote control units, remote sensors, portable lighting devices, portable radios, portable drills, digital cameras are common examples of such applications, devices and appliances. Rechargeable batteries are preferred over disposable batteries because they have a longer operating life, are more environmental friendly and offer a longer-term cost savings. For remote applications, rechargeable batteries are probably the only practical choice.

In general, rechargeable batteries may comprise a single battery cell or a plurality of battery cells connected in series. The voltage of each battery cell is typically between 1-2 volts and more commonly in the region of 1.2 to 1.5 volts. For example, a typical dry rechargeable Nickel Metal Hydride (NiMH) battery cell has a rated voltage of 1.2 volt.

As a result of improvements in battery technologies and the increasing demand for batteries with a higher power density to feed high drain rate devices such as digital cameras, batteries with enhanced capacities are available. For example, dry rechargeable AA batteries with a capacity of over 2000 mAH and above are now commonly available and further enhancement in battery power density can be expected. The GP® 2100 series NiMH batteries offered by the Gold Peak® Group are an example of high power density rechargeable batteries for general application.

Rechargeable batteries require repeated charging to perform as a source of renewed energy for repeated discharging and battery chargers are provided for such purposes. A typical battery charger comprises a charging power source and battery charging circuitry. The charging power source is usually either a constant current source or a constant voltage source. The battery charging circuitry provides an interface between the charging power source and the batteries to be charged. For the more sophisticated or intelligent battery chargers, control and monitoring circuitry are also provided so that the battery charging conditions can be more optimally controlled and monitored. An example of an intelligent battery charger (developed by the assignee of the present invention) is described in U.S. Pat. No. 6,580,249 and the content of which is incorporated herein by reference.

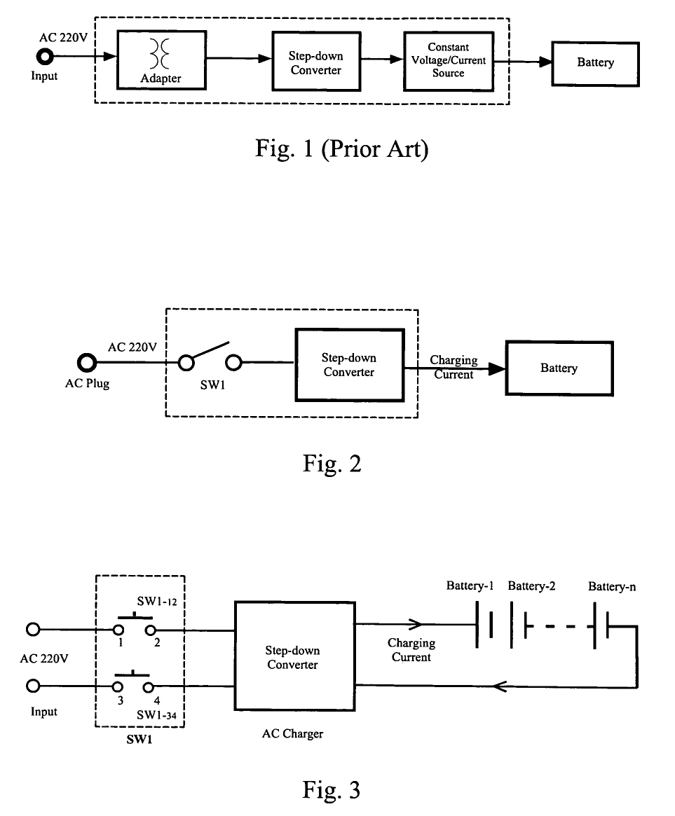

An example of a conventional battery charger is shown in FIG. 1. The prior art battery charger of FIG. 1 comprises an isolation transformer, a voltage down-converter and a constant current source (or a constant voltage source) which are contained within a main housing. The constant voltage or constant current source usually comprises a switch mode power supply (“SMPS”) so that the output is up converted from the 50 or 60 Hz AC mains frequency into a substantially higher frequency, for example, 10 kHz to 100 kHz. In such a conventional charger, it is not uncommon that the power supply section, comprising the power transformer and the voltage down-converter, dominates the space and weight of the entire charger. In some battery chargers, the power supply section is provided as a detachable adaptor with an AC input and a DC output. The main charger unit comprises a DC input which is connected to the charging circuitry with charging terminals disposed for receiving the batteries to be charged.

In many applications using batteries, the power supply of a device is formed by a serial connection of a plurality of batteries, for example standard sized batteries such as A, AA, AAA, C, D or 9-volt batteries, and the operating voltage is usually significantly less than the AC mains supply voltage. For example, many portable devices are powered by 4 to 6 standard sized batteries and the maximum voltage is usually less than 9 volts. On the other hand, the charging power source of a battery is usually conveniently obtained from the AC mains. To provide a suitable voltage for battery charging as well as safety isolation to protect users from electric shock and to comply with various safety regulations and standards, isolation transformers are usually included in a battery charger and concealed within an insulated housing. Of course, the reference to standard sized batteries is for example only and batteries of new sizes and/or types will become “standard-sized batteries” as demands justify. For example, lithium-ion batteries may be available in standard sizes.

The widespread use of rechargeable batteries, especially in consumer applications, also sees an increased demand on fast battery chargers. The term “fast battery chargers” is commonly understood by persons skilled in the art as referring to battery chargers which are capable of charging an empty battery to its fully charged state in an hour or less. A fast battery charger which are designed to fully charge a battery to its fully charged state in one hour is commonly known as a “1 C” charger and such a battery charger is equipped with a “1 C” current source or a current source with a “1 C” rating. For example, for a rechargeable battery of 2,000 mAH capacity, the 1 C charging current rate is 2 A and the 2 C charging current rate is 4 A. It is known that battery chargers usually utilise high frequency pulsed charging current with a relatively high current rate for fast charging. For example, a 4 C current source is used for a 15-minute fast battery charger and vice versa.

The increase in battery power density coupled with the demand on fast battery charging naturally translates into the requirement of a power supply of a higher power rating for battery chargers. For a battery charger adopting conventional designs, this means the need of a bulkier transformer which is both expensive and contrary to the trend of a slim and light design. With the continuing trend of development of high-power density batteries and even faster battery chargers, it can be expected that the isolation power transformers will become even more dominating in costs, weight and space to an unreasonable extent, if the conventional approach is used. Hence, it will be desirable if there can be provided improved battery chargers, especially fast battery chargers, so that shortcomings of conventional design approaches can be alleviated.

### OBJECT OF THE INVENTION

Accordingly, it is an object of the present invention to provide battery chargers which alleviate shortcomings of conventional battery charger designs. More specifically, it is an object of the present invention to provide battery chargers and topologies for battery chargers more suitable for fast battery chargers. At a minimum, it is an object of the present invention to provide the public with choices of battery charger topologies.

### SUMMARY OF THE INVENTION

According to the present invention, there is provided a battery charger comprising an AC power input, isolation switching means, isolation control means, battery charging circuitry and battery receptacle, said isolation switching means substantially isolates said battery charging circuitry from said AC power input unless and until actuated by said isolation control means, said isolation switching means connects said battery charging circuitry to said AC power input for battery charging when actuated, wherein the operation of said isolation switching means being linked to the state of electrical insulation of said battery charging circuitry, said isolation control means and said isolation switching means being cooperatively configured so that said isolation switching means is actuated when said battery charging circuitry is electrically insulated from a user and said isolation switching means is caused to isolate said battery charging circuitry and said AC power input when said battery charging circuitry is not electrically insulated from a user.

As a battery charger may comprise battery contacts connected to the battery charging circuitry and the battery contacts are electrical parts exposed to the battery receptacle, said isolation control means and said isolation switching means being advantageously configured so that said isolation switching means is actuated for battery charging when said exposed electrical parts are shielded for electrical insulation from access of a user.

In a preferred example of a charger, the isolation control means may comprise an insulating cover, said insulating cover being convertible between first and second configurations respectively corresponding to the opening and closure of said battery receptacle, said isolation switching means being actuated by closure of said battery receptacle when said exposed parts of said battery charging circuitry are electrically insulated from a user.

In a preferred embodiment, the battery charger comprises power conversion means, battery charging circuitry, isolation switch, battery receptacle, main housing, said power conversion means comprises means for converting an alternate current power input into a rectified power output for supplying a charging current to a battery in said battery receptacle via said battery charging circuitry, said battery charging circuitry comprises battery contact terminals which are adapted to provide connection between said charging circuitry and a battery received in said battery receptacle so that said charging current is supplied to said battery via said contact terminals, said isolation switch is connected between said alternate current power input and said battery contact terminals, said battery contact terminals are substantially isolated electrically from said alternate current power input unless and until said isolation switch has been actuated whereby said battery contact terminals and said alternate current power input are electrically connected, said main housing comprises an isolation cover which can be configured between first and second positions, wherein, at said first position, said battery contact terminals being substantially shielded by said isolation cover from external access with said isolation switch actuated and, at said second position, said battery receptacle being substantially opened with said battery contact terminals exposed to allow insertion and removal of a battery.

Preferably, said isolation cover comprises an insulating cover, said isolation cover and said battery receptacle together forms a substantially closed battery compartment when said isolation cover is at its first position, said isolation switch being actuated upon substantial closure of said battery compartment.

Preferably, said isolation switch being actuated and de-actuated respectively by the closing and opening motions of said battery compartment.

Preferably, said isolation switch comprises a multi-terminal switching device.

Preferably, said isolation switch comprises a four-terminal switching device with a pair of contact terminals connected to the side of said alternate current power supply and another pair of contact terminals connected to the side of said battery contact terminals.

Preferably, no isolation transformer being connected between said battery contact terminals and said alternate current power supply.

Preferably, said power conversion means comprises a switch-mode power converter and a step-down circuitry, said switch-mode power converter converts said alternate current power input into an output power by electronic switching, said stepping down circuitry converts the output power of said switch-mode power converter into an output power of a lower frequency content and with a lower power amplitude suitable for charging said battery.

Preferably, the frequency of said output power being substantially higher than that of the input power.

Preferably, said switch-mode power converter comprises a MOSFET with an optically coupled control gate terminal, said control gate of said MOSFET being connected to a micro-controller.

Preferably, said step-down circuitry comprises an integrating circuitry to convert a high frequency chopped power to a low frequency continuous power of a lower amplitude, the frequency of said electronic switching of said switch-mode power converter being controlled by a micro-controller, said chopping frequency of said switch-mode power converter being dependent on the output of said charging circuitry.

Preferably, said main housing provides an insulated housing to said electronic power conversion apparatus and said isolation switch, said battery contact terminals being exposed to said battery receptacle and said isolation switch being actuated and de-actuated respectively upon closure and opening of said isolation cover.

Preferably, said isolation cover being closed during normal battery charging.

Preferably, said isolation switch being mechanically actuated and deactivated respectively by closing and opening movements of said isolation cover.

Preferably, said battery contact terminals being relative movable so that a battery can be clamped or released by said contact terminals, said contact terminals being moved into and out of a battery clamping position respectively by closure and opening of said isolation cover.

### BRIEF DESCRIPTION OF THE PREFERRED EMBODIMENTS

Preferred embodiments of the present invention will be explained in further detail below by way of examples and with reference to the accompanying drawings, in which:—

FIG. 1 is a simplified schematic block diagram showing a conventional battery charger,

FIG. 2 is a simplified schematic diagram showing the general topology of a battery charger of the present invention,

FIG. 3 is a simplified schematic block diagram showing a preferred embodiment of a circuit topology of the charger of FIG. 1,

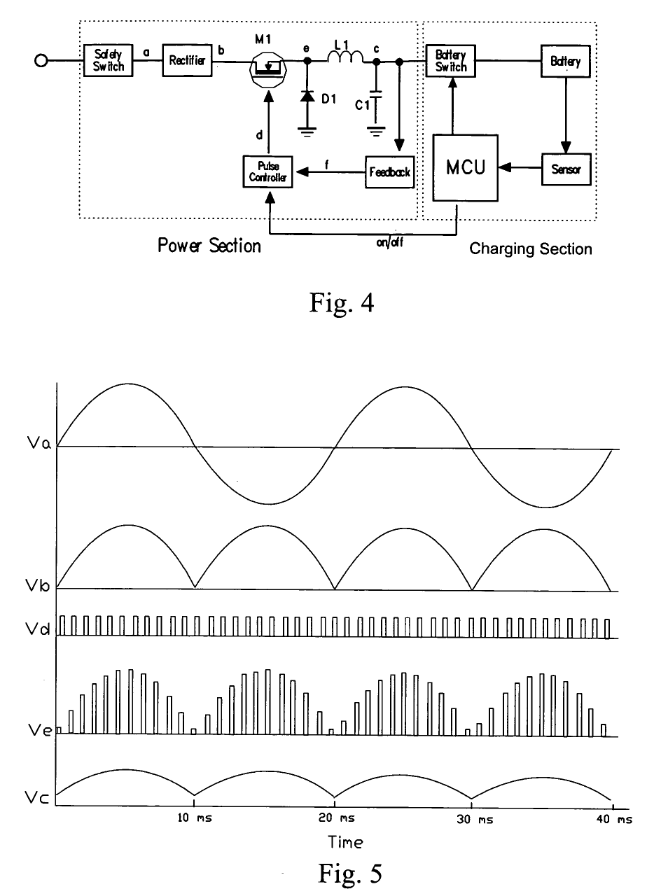

FIG. 4 is a hybrid circuit and block diagram showing in more detail the circuit of a first preferred example of a battery charger of this invention,

FIG. 5 is a voltage-time diagram illustrating the voltage time waveform at various nodes of the circuit of FIG. 4,

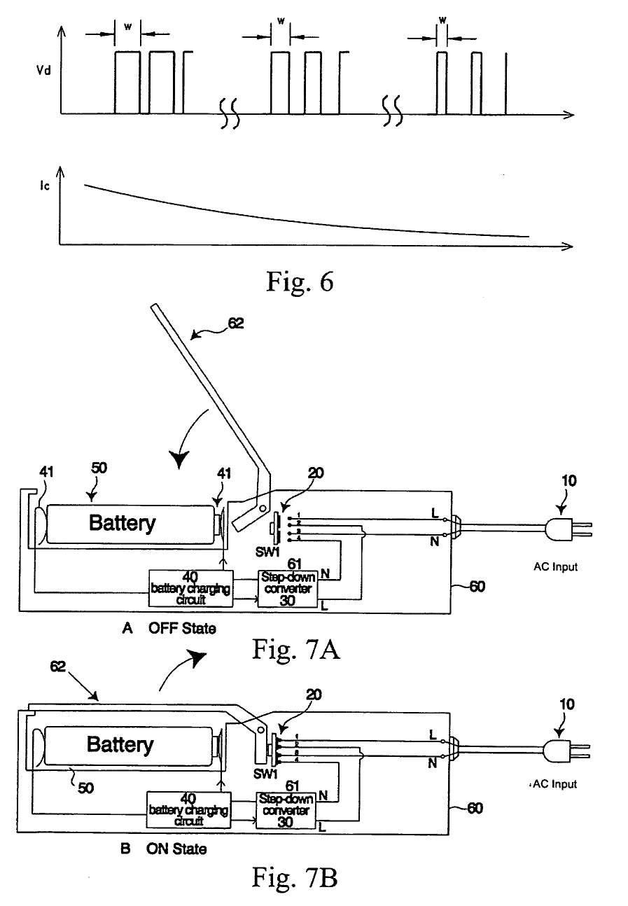

FIG. 6 is an exemplary pulse diagram showing a general relationship between charging current and the variable pulse width of a typical PFM constant current source,

FIG. 7A shows a first preferred embodiment of a battery charger of the present invention in its OFF state,

FIG. 7B shows the battery charger of FIG. 7A in its ON state,

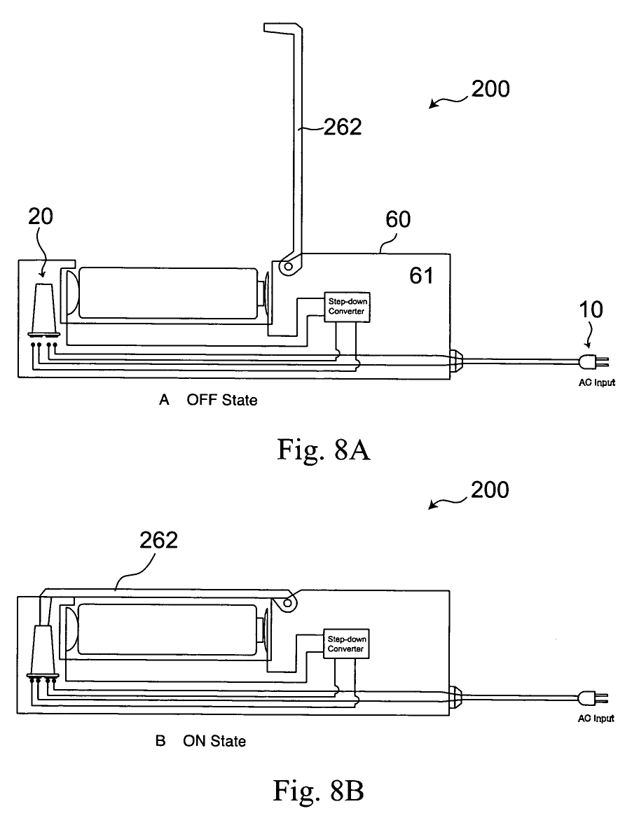

FIG. 8A shows a second preferred embodiment of a battery charger of the present invention in its OFF state,

FIG. 8B shows the battery charger of FIG. 8A in its ON state,

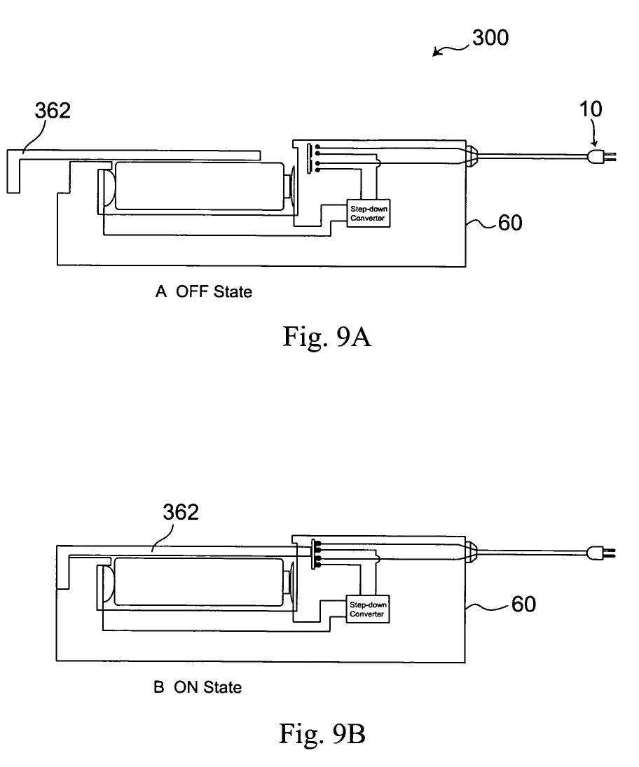

FIG. 9A shows a third preferred embodiment of a battery charger of the present invention in its OFF state,

FIG. 9B shows the battery charger of FIG. 9A in its ON state,

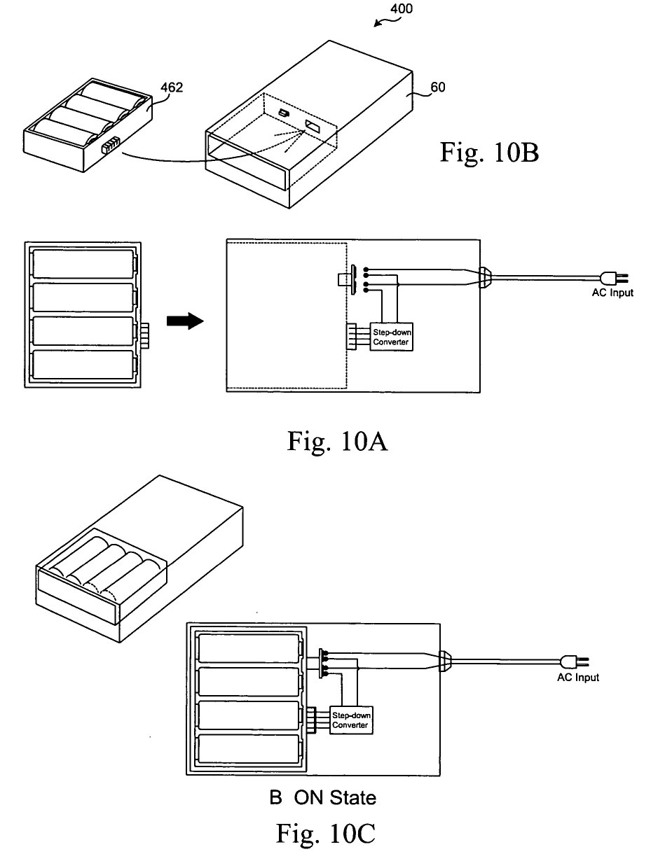

FIG. 10A illustrates a fourth preferred embodiment of a battery charger of the present invention,

FIG. 10B is a perspective view showing the intended insertion of a battery cartridge into a battery charging compartment of the battery charger of FIG. 10A,

FIG. 10C illustrates, both in plan and perspective views, the fast battery charger of FIG. 10A at its ON state,

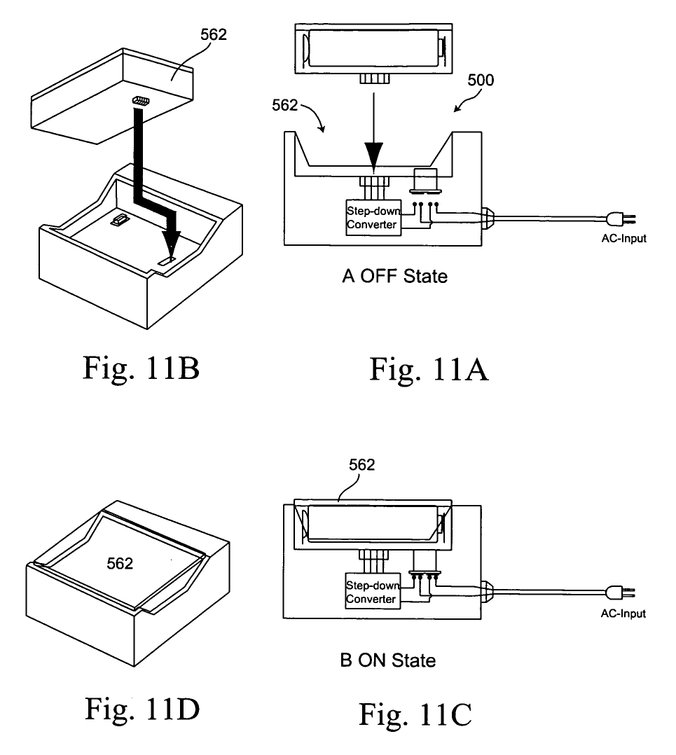

FIG. 11A illustrates a schematic elevation view of a fifth preferred embodiment of a battery charger of the present invention,

FIG. 11B is a perspective view showing the intended insertion of a battery cartridge into a battery charging compartment of the battery charger of FIG. 11A,

FIG. 11C is a schematic elevation view of the charger of FIG. 11A showing the battery charger in its ready for charging position, and

FIG. 11D is a perspective view of FIG. 11C.

### DETAILED DESCRIPTION OF THE PREFERRED EMBODIMENTS

A typical conventional battery charger as shown in FIG. 1 comprises an alternate current (AC) power input, a power conversion means (comprising an isolation transformer and a step-down converter), a constant voltage/current source, battery charging circuitry (including battery contacts) and battery receptacles for removably receiving the batteries to be charged. The isolation transformer, the step-down converter and the constant voltage/current source are usually housed and concealed within an insulated main housing so that no exposed electrical parts of a high electrical potential are accessible from the outside, thereby minimising the risk of electric shock to a user, especially a consumer. The battery receptacle and the battery contact terminals are usually disposed so that batteries to be recharged are compressively held to minimise contact resistance.

In order to facilitate fast charging to a plurality of batteries simultaneously, a typical battery charger nowadays comprises a plurality of battery charger sections with a charging current source adapted to provide charging currents at the rate of 1 C, 2 C, 3 C or above. To meet these charging current requirements, the weight of the power supply becomes more and more dominant compared to the entire charger. To make a battery charger less bulky, many chargers comprise a power supply unit and a charging unit which are detachable. The power supply unit is usually enclosed within an insulated housing and typically comprises an AC power input, an isolation transformer and a power converter, for example, a switch-mode power converter with a rectified or DC output. The charging unit typically comprises a DC power input, charging circuitry, charging monitor and control circuitry (which is preferably microcontroller based) and a battery receptacle for mounting the batteries to be charged.

Referring to FIG. 2, there is shown a general schematic diagram showing a battery charger of the present invention. The battery charger comprises an AC power input, an isolation switching means, power conversion means and a battery receptacle which are housed together in a main housing, more particularly an insulated housing such as a plastics housing. The active electrical parts of the battery charger, except the AC connector and the battery contact terminals, are enclosed within the insulated housing to alleviate the risks of electric shock to a user. The battery terminals are exposed to the battery receptacle so that batteries can be inserted for charging and removed charging has completed. The AC power input connects the battery charger to the AC mains or other appropriate AC power supply. The isolation switching means provides controllable isolation between the AC power input and the rest of the charger, for example, the power conversion means and the charging circuitry, as and when desired.

The power conversion means in this example comprises a step-down converter with an output voltage appropriately higher than the rated voltage of the batteries to be charged to facilitate effective charging. The power conversion means in this example comprises a switch-mode power supply for a constant voltage or a constant current output. A high frequency chopped output power supply commonly known in the art, for example, a switch mode power supply with a chopping frequency of between 10 kHz-100 kHz, and more preferably in the range of 20 kHz and 35 kHz, may be used. The switch power may be modulated in pulse frequency modulation (PFM) or pulse width modulation (PWM) as examples. The charging circuitry provides an interface between the charging current source and the batteries received in the battery receptacle via battery contact terminals. The battery receptacle is adapted for detachably or removably receiving a battery or a plurality of batteries to be charged.

In order to alleviate of risks of electric shock to a user, the isolation switching means is provided intermediate the AC power source and the user accessible electrical parts such as the battery contact terminals. In a preferred embodiment as shown in FIG. 3, the isolation switching means comprises a four-terminal contact switch with a pair of contact terminals disposed on the AC input side and another pair of contact terminals disposed on the charging circuitry side. The use of a four terminal switch in the present example provides a double safety so that both the live and neutral terminals are disconnected from the power conversion means or the charging circuitry (and hence a user) unless and until the isolation switching means is activated to form a low impedance circuit between the power conversion means and the AC power supply. Of course, two-terminal or multi-terminal electrical switches can be used without loss of generality. Examples of switches suitable for use as an isolation switch of this invention includes mechanical switch, relay switch and electronic switches such as MOSFETS and IGFET. Furthermore, although a serial type charger is shown in FIG. 3, it will be appreciated that the invention applies to the parallel type of chargers. As can be seen from the embodiments below, the operation of the isolation switching means is linked to the state of electrical insulation of the charger, and more particularly the electrical insulation state of the battery receptacle and more specifically the battery contacts. The isolation switch is actuated to connect the battery charging circuitry and the AC power supply when the electrical insulation of the battery receptacle is sufficient to alleviate risks of inadvertent electric shock to a user. In an example, the actuation of the isolation switching means to connect the AC input and the battery charging circuitry is linked, for example, synchronised, with the closure of the battery receptacle.

Turning now to an exemplary battery charging circuitry as shown in FIG. 4 embodying the present invention, the power conversion means comprises a rectifier, a switch mode power supply, a battery switch, a battery receptacle, battery sensor and a microcontroller (MCU). In this example, it will be appreciated that the microcontroller serves a dual role of controlling the switch mode power supply and the battery charging circuitry.

The switch mode power supply of FIG. 4 comprises a modulation switch M1 and an integrator. The switch is a high-frequency MOSFET suitable for switching in the 100 kHz range. The integrator comprises an inductor L1 connected in series between the switch M1 and the power output, a capacitor C1 connected between the output of the inductor L1 and the reference ground and a diode D1 connected between the input of the inductor L1 and the reference ground with the cathode in common with the switch M1 and the inductor L1. The typical waveforms at the various nodes on the circuitry and marked a to be are shown in FIG. 5.

Referring to FIG. 5, it will be noted that the voltage waveform at node a is a typical 50/60 Hz AC mains supply waveform. The AC power input is then rectified by the rectifier to produce a DC output suitable for battery charging. To provide a constant voltage or a constant current source, the rectified power at node n is high-frequency chopped by applying switching pulses to the gate terminal of the modulation switch M1 as shown by the pulses at node d. It will be appreciated that the voltage and/or current output amplitude can be controlled by the frequency or by varying the duty cycle of the switching pulses in order to maintain a substantially constant voltage or current. The integrator is adapted to provide a rippled DC charging output current or voltage as rippled output is known to be more efficient fro battery charging. In this example, the MCU controls the modulation switching frequency of M1 and the switching time or frequency is variable depending on the feedback of the charging circuitry. An example of the relationship between the charging current and the switching frequency or pulse period in the PFM is shown in FIG. 6. It will be noted from the PFM waveform that the current decreases with an increase of the period, given a constant pulse width. In addition, the MCU also monitors the charging conditions of the batteries so that a battery or batteries can be bypassed when desirable or necessary. Furthermore, the MCU can also operate a battery switch so that open circuit parameters can be measured by electrically isolating the batteries from the charging circuitry as and when necessary.

Referring to FIGS. 7A & 7B, there is shown a first preferred embodiment of a battery charger 100 embodying the present invention. The battery charger comprises an AC power input 10, a multi-terminal isolation switch (SW1) 20, a step-down power converter 30, battery charging circuitry 40 including battery terminal contacts 41, battery receptacle 50 and a main housing 60. The main housing comprises a compartment 61 for housing the isolation switch SW1, the power converter and the battery charging circuitry and a battery compartment defined by a movable isolation cover 62 and the battery receptacle 63. Battery contact terminals 61 which are adapted for providing an interface between the charging circuitry and the batteries are exposed to the battery receptacle 50 so that a battery can be connected to the charging circuitry (and preferably compressively held by the battery terminal contacts) after being placed inside the battery receptacle. The multi-terminal isolation switch SW1 comprise four contact terminals separated into two pairs. The first (terminals 1 & 2) and the second (terminals 3 & 4) pairs being respectively for making connection along the live and neutral lines of an AC power supply. The making and braking contacts of the isolation switch is mechanically connected to the isolation cover. The isolation cover is moveable between first and second positions. In the first position, as shown in FIG. 7B, the isolation cover is disposed so that the isolation cover and the battery receptacle together define a substantially closed battery compartment with the battery contact terminals shielded from and normally not accessible by a user. In the second position, as shown in FIG. 7A, the isolation cover is opened (or partly opened) with the battery contact terminals exposed for access so that batteries can be inserted into or removed from the battery receptacle. It will be noted that the making and breaking contact of the isolation switch is by a lever type mechanism which is operated by a user so that there will be no charging power supply to the batteries unless and until a user has closed the isolation cover. When the isolation cover is closed, the making and breaking contact is pushed towards the four terminals, thereby completing the electrical path between the AC input and the charging circuitry. Although a mechanical switch SW1 is used as a preferred embodiment in this example, it will be appreciated that electronic switches can be used. For example, the four-terminal switch can be formed by a pair of MOSFETS or IGFETS with their drain terminals tied respectively to terminals 1 & 3 and the source terminals tied to terminals 2 & 4. On the other hand, when a two-terminal switch is used, the two terminals can be connected to terminal pairs 1-2 or 3-4 with the other pair of terminals already connected, so that the two-terminal switches will switch the live or neutral line connections respectively. Of course, a pair of two terminal switches can be used instead of a 4-terminal switch without loss of generality.

Referring to FIGS. 8A, 8B, 9A & 9B, there are shown second and third preferred embodiments of a battery charger embodying the present invention. The battery charger may comprise the circuitry of FIG. 4 or other appropriate circuitry suitable for the purpose. For the purpose of this invention, the charger is substantially identical to that of FIGS. 7A & & 7B except for the isolation cover and the disposition of the isolation switch. The main housing comprises an isolation cover and a battery receptacle which cooperate to form a closed battery compartment when the isolation cover is at its first position as described above.

In the second preferred embodiment 200 of FIG. 8A & 8B, the free, un-pivoted, end of the isolation cover 262 comprises a hook-shaped member. The isolation switch is disposed so that when the isolation cover is properly closed so that the battery terminals are shielded by the isolation cover from external access, the hook-shaped member will actuate the contact isolation switch by pushing the making and breaking terminal of the isolation switch towards the contact terminals, thereby completing the circuit connection. W hen the isolation cover 262 is opened, the contact between the switch terminals is broken, thereby isolating the charging circuitry from the AC mains.

In the third preferred embodiment 300 of FIGS. 9A & 9B, the main housing 60 comprises an isolation cover 362 and a battery receptacle which cooperate to form a closed battery compartment when the isolation cover is at its first position as described above. The isolation cover is disposed as a slidable battery compartment door which pushes the making and breaking contact of the isolation switch towards the making configuration when the isolation cover is pushed into the first position when the battery contacts are shielded.

In the fourth 400 and fifth 500 preferred embodiments of the battery charger as respectively shown in FIGS. 10A to 10C and FIGS. 11A to 11D, the battery charger comprises a cartridge-type battery module for insertion into the battery receptacle. The battery module comprise an insulated and shielded housing 462, 562, for example a plastic housing, with interfacing contacts (such as a plug and socket pair) disposed at the bottom so that the interfacing contacts are shielded and not accessible by a user once the battery module is duly inserted in place. As a convenient example, the cartridge is dimension to hold 4 pieces of AA or AAA sized batteries. Of course, cartridges for holding other batteries are accordingly dimensioned without loss of generality.

In these embodiments, the main housing, the battery contact terminals, the isolation switch and the battery module are arranged so that the isolation switch will be actuated only when the battery module is properly placed inside the battery. To facilitate this, the battery module and the main housing have correspondingly disposed interfacing means and actuation means. The interfacing means provides electrical contacts between the battery contact terminals on the main housing and the battery module. The actuation means being disposed for cooperative actuation of the isolation switch to facilitate charging power supply to the charging circuitry and the battery contact terminals. In the Figures and the description, the same numerals are used to designate the same, equivalent or common parts where appropriate and when the context allows.

Generally speaking, this invention has described a battery charger with an AC power input and user controllable isolation switching means connected in series intermediate the AC power input and the charging circuitry output, said isolation switching means being adapted to substantially isolate or disconnect the AC power supply from the battery charging circuitry when the battery charging circuitry is electrically exposed and accessible to a user and to connect the AC power supply from the battery charging circuitry when the battery charging circuitry is electrically insulated or shielded by a user.

While the present invention has been explained by reference to the preferred embodiments described above, it will be appreciated that the embodiments are illustrated as examples to assist understanding of the present invention and are not meant to be restrictive on the scope and spirit of the present invention. The scope of this invention should be determined from the general principles and spirit of the invention as described above. In particular, variations or modifications which are obvious or trivial to persons skilled in the art, as well as improvements made on the basis of the present invention, should be considered as falling within the scope and boundary of the present invention.

Furthermore, while the present invention has been explained by reference to fast battery chargers and chargers for consumer applications, it should be appreciated that the invention can apply, whether with or without modification, to other battery chargers without loss of generality.

1. A battery charger comprising an AC power input, isolation switching means, isolation control means, battery charging circuitry and battery receptacle, said isolation switching means substantially isolates said battery charging circuitry from said AC power input unless and until actuated by said isolation control means, said isolation switching means connects said battery charging circuitry to said AC power input for battery charging when actuated, wherein the operation of said isolation switching means being linked to the state of electrical insulation of said battery charging circuitry, said isolation control means and said isolation switching means being cooperatively configured so that said isolation switching means is actuated when said battery charging circuitry is electrically insulated from a user and said isolation switching means is caused to isolate said battery charging circuitry and said AC power input when said battery charging circuitry is not electrically insulated from a user.

2. A battery charger according to claim 1, wherein said battery charging circuitry comprises electrical parts exposed to said battery receptacle, said isolation control means and said isolation switching means being configured so that said isolation switching means is actuated for battery charging when said exposed electrical parts are shielded for electrical insulation from access of a user.

3. A battery charger according to claim 2, wherein said isolation control means comprises an insulating cover, said insulating cover being convertible between first and second configurations respectively corresponding to the opening and closure of said battery receptacle, said isolation switching means being actuated by closure of said battery receptacle when said exposed parts of said battery charging circuitry are electrically insulated from a user.

4. A battery charger according to claim 1, further comprising power conversion means and a main housing, said isolation switching means being an isolation switch, wherein
said power conversion means comprises means for converting an alternate current power input into a rectified power output for supplying a charging current to a battery in said battery receptacle via said battery charging circuitry,
said battery charging circuitry comprises battery contact terminals which are adapted to provide connection between said charging circuitry and a battery received in said battery receptacle so that said charging current is supplied to said battery via said contact terminals,
said isolation switch is connected between said alternate current power input and said battery contact terminals, said battery contact terminals are substantially isolated electrically from said alternate current power input unless and until said isolation switch has been actuated whereby said battery contact terminals and said alternate current power input are electrically connected,
said main housing comprises an isolation cover which can be configured between first and second positions, wherein, at said first position, said battery contact terminals being substantially shielded by said isolation cover from external access with said isolation switch actuated and, at said second position, said battery receptacle being substantially opened with said battery contact terminals exposed to allow insertion and removal of a battery.

5. A battery charger according to claim 4, wherein said isolation cover comprises an insulating cover, said isolation cover and said battery receptacle together forms a substantially closed battery compartment when said isolation cover is at its first position, said isolation switch being actuated upon substantial closure of said battery compartment.

6. A battery charger according to claim 5, wherein said isolation switch being actuated and de-actuated respectively by the closing and opening motions of said battery compartment.

7. A battery charger according to claim 4, wherein said isolation switch comprises a multi-terminal switching device.

8. A battery charger according to claim 7, wherein said isolation switch comprises a four-terminal switching device with a pair of contact terminals connected to the side of said alternate current power supply and another pair of contact terminals connected to the side of said battery contact terminals.

9. A battery charger according to claim 4, wherein no isolation transformer being connected between said battery contact terminals and said alternate current power supply.

10. A battery charger according to claim 4, wherein said power conversion means comprises a switch-mode power converter and a step-down circuitry, said switch-mode power converter converts said alternate current power input into an output power by electronic switching, said stepping down circuitry converts the output power of said switch-mode power converter into an output power of a lower frequency content and with a lower power amplitude suitable for charging said battery.

11. A battery charger according to claim 10, wherein the frequency of said output power being substantially higher than that of the input power.

12. A battery charger according to claim 10, wherein said switch-mode power converter comprises a MOSFET with an optically coupled control gate terminal, said control gate of said MOSFET being connected to a micro-controller.

13. A battery charger according to claim 10, wherein said step-down circuitry comprises an integrating circuitry to convert a high frequency chopped power to a low frequency continuous power of a lower amplitude, the frequency of said electronic switching of said switch-mode power converter being controlled by a micro-controller, said chopping frequency of said switch-mode power converter being dependent on the output of said charging circuitry.

14. A battery charger according to claim 4, wherein said main housing provides an insulated housing to said electronic power conversion apparatus and said isolation switch, said battery contact terminals being exposed to said battery receptacle and said isolation switch being actuated and de-actuated respectively upon closure and opening of said isolation cover.

15. A battery charger according to claim 14, wherein said isolation cover being closed during normal battery charging.

16. A battery charger according to claim 14, wherein said isolation switch being mechanically actuated and deactivated respectively by closing and opening movements of said isolation cover.

17. A battery charger according to claim 14, wherein said battery contact terminals being relative movable so that a battery can be clamped or released by said contact terminals, said contact terminals being moved into and out of a battery clamping position respectively by closure and opening of said isolation cover.
